(19) United States
(12) Patent Application Publication
(10) Pub. No.: US 2017/0366661 A1
(43) Pub. Date: Dec. 21, 2017

(54) ADD TEXT AND AUDIO TO A SELFIE

(71) Applicant: Angel Macklin, Gary, IN (US)

(72) Inventor: Angel Macklin, Gary, IN (US)

(21) Appl. No.: 15/629,582

(22) Filed: Jun. 21, 2017

Related U.S. Application Data
(60) Provisional application No. 62/352,935, filed on Jun. 21, 2016.

(51) Int. Cl. H04M 1/725; G06T 11/60; G06F 3/0482

(52) U.S. Cl. CPC H04M 1/72555; G06F 3/0482; G06T 11/60

(57) ABSTRACT

A smart phone/apparatus/machine configured to enable a user to take a picture and associate audio and text data to the picture immediately thereafter, and then send such associated data to others.

### CROSS-REFERENCE TO RELATED APPLICATION

The present application is related to and claims priority from prior provisional application Ser. No. 62/352,935, filed Jun. 21, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile phones and more particularly to a system and method immediately adding audio and text to pictures selected, then stored and shared via mobile phones

### 2. Description of the Related Art

The present invention relates generally to the field of mobile phones and more particularly to a system and method adding audio and text to pictures taken, stored and shared via mobile phones.

Accordingly, various prior arts have disclosed such related inventions, whereby the provided following patents are herein incorporated by reference for their supportive teachings and enablement criteria for the technology needed to enable one skilled in the art to make and use the subject invention, in which:
U.S. Pat. No. 8,416,305, ISSUED Apr. 9, 2013, discloses a portable wi-fi digital video camcorder and system.
US application no.: 2010/0281475, pub. Date: Nov. 4, 2010, discloses a system and method for mobile smartphone applications development and delivery.
U.S. Pat. No. 8,724,004, issued May 13, 2014, discloses a mobile terminal and tag editing method.
US Patent app. no.: 2006/0110154, pub. Date: May 25, 2006, disclose a method of adding metadata to pictures.
US. Patent app. No.: 2004/0027474, pub. Data: Feb. 12, 2004, discloses a cellular telephone that has a camera built therein.
U.S. Pat. No. 7,633,535, issued Dec. 15, 2009, discloses an apparatus for adding user supplied text to a digital still image for printing thereof on a printer.
U.S. Pat. No. 9,578,186, issued: Feb. 21, 2017, discloses an image display apparatus having image related information displaying function.
US. Patent app. No.: 2009/02800859, pub. Data: Nov. 12, 2009, discloses an automatic tagging of photos in mobile devices.
U.S. Pat. No. 9,367,832, issued: Jun. 14, 2016, discloses a synchronizing image data among applications and devices.
U.S. Pat. No. 9,021,045, issued Apr. 28, 2015, discloses sharing images in a social network.
U.S. Pat. No. 9,367,864, issued Jun. 14, 2016, discloses experience sharing with commenting.
U.S. Pat. No. 8,312,392, issued Nov. 13, 2012, discloses user interface gestures and methods for providing file sharing functionality.
US. Patent app. No: 2016/0011758, pub. Date: Jan. 14, 2016, discloses a system, apparatuses and methods for a video communications network.
U.S. Pat. No. 8,949,370, issued Feb. 2, 2015, discloses a mobile application generation system.
U.S. Pat. No. 9,026,905, issued May 5, 2015, discloses customization of mobile applications using web-based technology.
US. Patent app. 2012/0035923 pub. Date: Feb. 9, 2012, discloses an in-vehicle texting messaging experience engine.
US. Patent app. 2011/0212737, pub. Data: Sep. 1, 2011, teaches of a mobile communication device.

Despite the various teachings of the incorporated references provided above, none of the art taken singly or in combination is believed to teach the following invention. In particular, users are fascinated with taking pictures of themselves at various locations; these pictures are called SELFIES. Up to this time, there has not been a mobile phone application that allows for the user to immediately add both audio and text to these pictures before sending them to others.

### BRIEF SUMMARY OF THE INVENTION

In view of the foregoing disadvantages inherent in the known types of apparatus like in the prior art, the present invention provides an improved apparatus. As such, the general purpose of the present invention, which will be described subsequently in greater detail, is to provide a new and improved apparatus with all the advantages of the prior art and none of the disadvantages.

Accordingly, it is a goal of the present invention to provide a machine/apparatus/smartphone/application configured to enable a user to take a picture and immediately associate audio and text data to the picture thereafter, and then send such associated data to others.

In one embodiment, the machine comprising a computing device, having an applications processor, designed to control the processing of data needed to operate the machine; a memory, operatively coupled to the applications processor, for storing at least a portion of software needed by the applications processor; an audio module, operatively coupled to the applications processor, designed to enable a user to create audio data; a communications module, operatively coupled to the applications processor, designed to enable the machine to send and receive data from other users having other similar machines.

In another embodiment the machine includes a camera, operatively coupled to the computing device, designed to create pictures and save them to the memory; a display, operatively coupled to the computing device, designed to display the pictures, and to provide interaction with the user of the machine.

In yet a further embodiment of the invention, the machine includes in a first step of operation, the machine prompts the user via the display to select a picture, either taken by the camera or stored in memory.

In yet a further embodiment of the invention, the machine includes in a second step of operation, the machine prompts the user to record audio data and thereby attaching the audio data to the selected picture.

In yet a further embodiment of the invention, the machine includes in a third step of operation, the machine prompts the user to create a text caption data to be displayed on the selected picture and thereby attaching the text caption data to the selected picture and audio data.

In yet a further embodiment of the invention, the machine includes in a forth step of operation, the machine prompts the user to send to other users, via the communication module, the associated text caption data, audio data and selected picture.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments and method(s) of use for the present invention, Add Text and Audio To A Selfie, constructed and operative according to the teachings of the present invention.

FIG. 1 is a block diagram representation of an example, mobile computing device.

FIG. 1a is another block diagram representation of an example mobile computing device.

FIG. 2 is one embodiment of the invention including a screen shot of a navigation page.

FIG. 3 is one embodiment of the invention including a screen shot of a home page.

FIG. 4 is one embodiment of the invention including a screen shot of a sent page.

FIG. 5 is one embodiment of the invention including a screen shot of a first step.

FIG. 6 is one embodiment of the invention including a screen shot of a picture selection page.

FIG. 7 is one embodiment of the invention including a screen shot of an audio adding page.

FIG. 8 is one embodiment of the invention including a screen shot of an audio display page.

FIG. 9 is one embodiment of the invention including a screen shot of a caption to add page.

FIG. 10 is one embodiment of the invention including a screen shot of a caption added page.

FIG. 11 is one embodiment of the invention including a screen shot of a send picture page.

FIG. 12 is one embodiment of the invention including a screen shot of a delete options page.

FIG. 13 is one embodiment of the invention including a screen shot of INAPPROPRIATE material alert.

FIG. 14 is one embodiment of the invention including a flow chart.

The various embodiments of the present invention will hereinafter be described in conjunction with the appended drawings, wherein like designations denote like elements.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. Any figures and accompanied descriptions provided in the background art provided above are to also be considered in the understanding of the present invention and potential operation thereof. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent to one skilled in the art from the following detailed description of the invention when considered in conjunction with the drawings and the other incorporated by reference art provided.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

It is understood that the use of specific component, device and/or parameter names (such as those of the executing utility/logic described herein) are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. For example, as utilized herein, the following terms are generally defined:

(1) Mobile computing/communication device (MCD): is a device that may be a mobile communication device, such as a cell phone, or a mobile computer that performs wired and/or wireless communication via a connected wireless/wired network. In some embodiments, the MCD comprises a combination of the functionality associated with both types of devices within a single standard device (e.g., a smart phones or personal digital assistant (PDA)) for use as both a communication device and a computing device.

Referring now to the figures, each of which is presented with a brief and introductory descriptions followed by general references to certain select portions of the figures and/or a general description of the functionality associated with or illustrated by the particular figure(s). Within the descriptions of the figures, similar elements are provided similar names and reference numerals as those of the previous figure(s). The specific numerals assigned to the elements/components/blocks/features are provided solely to aid in the description and not meant to imply any limitations (structural or functional or otherwise) on the described embodiment.

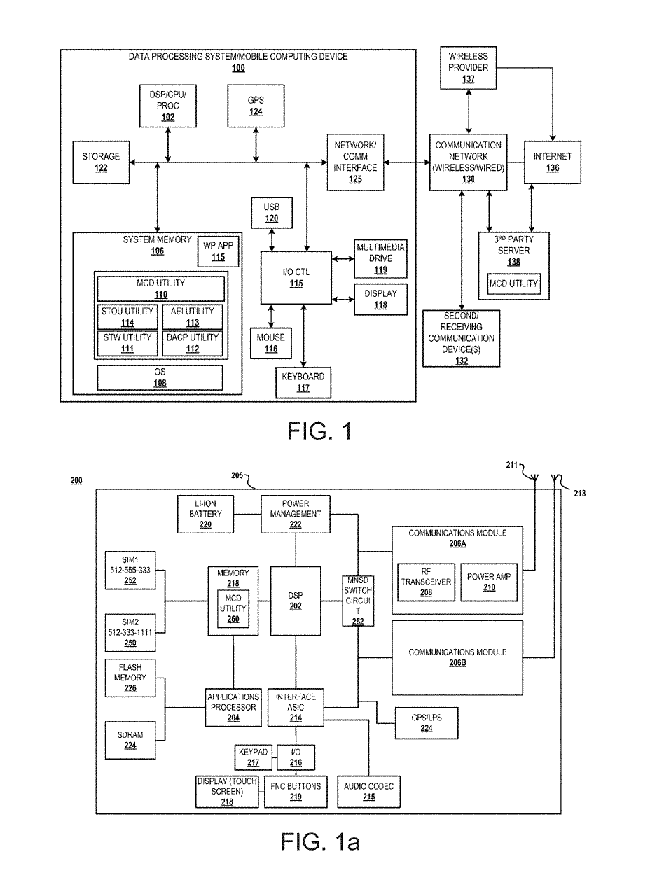

With specific reference now to the figures, and beginning with FIG. 1, there is depicted one embodiment of a block diagram representation of an example mobile computing device (MCD), within which several of the features of the described embodiments may be implemented. MCD 100 may be a desktop computer, a portable computing device, such as a laptop, personal digital assistant (PDA), a smart phone, and/or other types of electronic devices that may generally be considered processing devices. As illustrated, MCD 100 comprises at least one processor or central processing unit (CPU) 102 connected to system memory 106 via system interconnect/bus 104. Also connected to system bus 104 is input/output (I/O) controller 115, which provides connectivity and control for input devices, of which pointing device (or mouse) 116 and keyboard 117 are illustrated. I/O controller 115 also provides connectivity and control for output devices, of which display 118 is illustrated. Additionally, a multimedia drive 119 (e.g., compact disk read/write (CDRW) or digital video disk (DVD) drive) and USB (universal serial bus) port 120 are illustrated, coupled to I/O controller 115. Multimedia drive 119 and USB port 120 enable insertion of a removable storage device (e.g., optical disk or “thumb” drive) on which data/instructions/code may be stored and/or from which data/instructions/code may be retrieved. MCD 100 also comprises storage 122, within/from which data/instructions/code may also be stored/retrieved. MCD 100 further comprises a global positioning system (GPS) or local position system (LPS) detection component 124 by which MCD is able to detect its current location (e.g., a geographical position) and movement of MCD 100, in real time. MCD 100 is also illustrated with a network/communication interface 125, by which MCD 100 may connect to one or more second communication devices 132 or to fireless service provider server 134, or to a third party server 138 via one or more access/external communication networks, of which a wireless network 132 is provided as one example and the Internet 136 is provided as a second example. It is appreciated that MCD 100 may connect to third party server 138 through an initial connection with service provider server 134, which in turns connects to third party server via the Internet 136.

In addition to the above described hardware components of MCD 100, various features of the described embodiments are completed/supported via software (or firmware) code or logic stored within memory 106 or other storage (e.g., storage 122) and executed by CPU 102. Thus, for example, illustrated within memory 106 are a number of software/firmware/logic components, including operating system (OS) 108 (e.g., Microsoft Windows® or Windows Mobile®, trademarks of Microsoft Corp, or GNU®/Linux®, registered trademarks of the Free Software Foundation and The Linux Mark Institute, and AIX®, registered trademark of International Business Machines), and (word processing and/or other) application(s) 115. Also illustrated are a plurality (four illustrated) software implemented utilities, each providing different one of the various functions (or advanced features) described herein. Including within these various functional utilities are: Simultaneous Text Waiting (STW) utility 111, Dynamic Area Code Pre-pending (DACP) utility 112, Advanced Editing and Interfacing (AEI) utility 112 and Safe Texting Device Usage (STDU) utility 114. In actual implementation and for simplicity in the following descriptions, each of these different functional utilities are assumed to be packaged together as sub-components of a general MCD utility 110, and the various utilities are interchangeably referred to as MCD utility 110 when describing the utilities within the figures and claims. For simplicity, the following description will refer to a single utility, namely MCD utility 110. MCD utility 110 may, in certain embodiments, be combined with one or more other software modules, including for example, word processing application(s) 115 and/or OS 108 to provide a single executable component. which then provides the collective functions of each individual software component when the corresponding combined code of the single executable component is executed by CPU 101. Each separate utility 111/112/113/114 is illustrated and described as a standalone or separate software/firmware component/module, which provides specific functions, as described below. As a standalone component/module, MCD utility 110 may be acquired as an off-the-shelf or after-market or downloadable enhancement to existing program applications or device functions, such as voice call waiting functionality (not shown) and user interactive applications with editable content, such as application within the Windows Mobile® suite of applications. In at least one implementation, MCD utility 110 may he downloaded from a server or website of a wireless provider (e.g., wireless provider server 132) or a third party server 138, and either installed on MCD 100 or executed from the server 132/138.

CPU 101 executes MCD utility 110 as well as OS 108, which, in one embodiment, supports the user interface features of MCD utility 110, such as generation of a graphical user interface (GUI), where required/supported within MCD utility code. In several of the described embodiments, MCD utility 110 generates/provides one or more GUIs to enable user interaction with, or manipulation of, functional features of MCD utility 110 and/or of MCD 100. MCD utility 100 may, in certain embodiments, enable certain hardware and firmware functions and may thus be generally referred to as MCD logic.

Certain of the functions supported and/or provided by MCD utility 110 are enabled as processing code/instructions/logic executing on DSP/processor 102 and/or other device hardware, and the processor thus completes the implementation of those function(s). Among the software code/instructions/logic provided by MCD utility 110, and which are specific to the described embodiments of the invention, are code/logic for performing several (one or a plurality) of the following functions: (1) Simultaneous texting during ongoing voice communication providing a text waiting mode for both single number mobile communication devices and multiple number mobile communication devices; (2) Dynamic area code determination and automatic back-filling of area codes when a requested/desired voice or text communication is initiated without the area code while the mobile communication device is outside of its home-base area code toll area; (3) Enhanced editing functionality for applications on mobile computing devices; (4) Automatic toggle from manual texting mode to voice-to-text based communication mode on detection of high velocity movement of the mobile communication device; and (5) Enhanced e-mail notification system providing advanced e-mail notification via (sender or recipient directed) texting to a mobile communication device.

Each of the methods described herein and illustrated by the block diagrams and flow charts are provided by program code or utility that is executed by/with one or more hardware devices of an MCD 100/200. For purposes of the various descriptions, these functional features and/or embodiments are described from the perspective of the MCD utility 110 and/or the MCD 100/200 performing or enabling the specific functions/features.

FIG. 1a is another embodiment of a block diagram representation of an example mobile communication device within which several of the features of the described embodiments may be implemented, in accordance with one embodiment. As with FIG. 1, for purposes of illustration and description herein, FIG. 1a illustrates an example MCD which is a mobile communication device, such as a cell phone, BlackBerry®, or other similar device. For simplicity in describing the invention, both mobile computing device and mobile communication device are collectively referred to as MCD, and specific features of the various described embodiments are applicable to any devices which generally fall within these general categories of devices. In one embodiment, the features of one or more embodiments of the various different embodiments are implemented within a dual subscriber number single device (DNSD) or a multiple number single device MNSD MCD. FIG. 1a illustrates such a DNSD MCD, and is described from that perspective. The structural features are described herein for inclusion with the present embodiments and application of the functionality which apply to such DNSD MCDs.

Referring now to FIG. 1a, internal circuit of MNSD MCD 200 (cellular phone) comprises two circuits, circuit A 210 and circuit B 250, coupled to a central processor 245 via a MNSD switching facility 247 controlled by central processor 245. Additional numbers of circuits may be similarly supported within MNSD MCD 200, and the various embodiments of the invention may also he implemented/practiced within a single number single device MCD. MNSD MCD 200 comprises at its core a baseband digital signal processor (DSP) 202, which handles the cellular communication functions, and an applications processor 204 on which the menu and other applications (e.g., an operating system and user applications) executes/runs. Antennae 211 and 213 are respectively connected to communications module 206A and 206B, which in this embodiment, each support a different, respective subscriber number, as will be described further below. Example communications module 206A comprises circuitry for completing wireless communication (transmit and receive digital voice and data signals) via antenna 211, including for example, RF transceiver 208 and power amplifier module 210. In the illustrative embodiment, communications modules 206A/206B are coupled to an MNSD switch circuit 262 that enables switching between one communications module or the next based on which subscriber number is currently active/activated. DSP 202 is coupled to an interface application specific integrated circuit (ASIC) 214 and an audio code-decode (CODEC) 216, which provide interfaces to a speaker and a microphone (not shown), and other input/output devices provided in the MNSD MCD 200, such as a numeric or alphanumeric keypad 217 for entering commands, text, numbers, data, and/or other information. In one embodiment, MNSD MCD 200 includes a touch screen display device 218, which serves as both an output (video) device as well as an input device (via user touching of the screen). Thus, input devices also include selection buttons 219 or icons for selection menu functions and other tools and options provided by various utilities provided/executing on MNSD MCD 200. Interface mechanisms comprising a graphical user interface (via LCD display) and an alphanumeric keypad 217 and certain function buttons/icons 219 (selectable via touch screen interface) are appropriately designed to support the MNSD functionality. MCD 200 also comprises GPS/US detection component 224, enabling real time detection of a current geographic position of MCD 200 and. any movement of MCD 200.

DSP 202 uses a flash memory 218 for code store, and flash memory 218 is enhanced with code for MCD utility 110. In alternate embodiments, the code for MCD utility 110 may be stored in (or distributed among) other storage modules within MNSD MCD 100. In the illustrative embodiment, MNSD MCD 200 may be powered by (lithium-ion) battery 220, and a power management module 222 coupled to DSP 202 manages power consumption within MNSD MCD 200. In one embodiment, power management is utilized to effectively reduce power to the circuit components/elements of the subscriber number not currently being utilized. When active communication is occurring on one subscriber number, the power management reduces power access to or causes the elements of the other subscriber number to go into a low power hibernation state to avoid any cross talk or interference. The response may be triggered by the MNSD utility which controls all multi-number functionality of the MNSD MCD 200.

SDRAM 224 and flash memory 226 provide volatile and non-volatile memory, respectively, for applications processor 204. This arrangement of memory holds the code for the operating system, the code for customizable features such as the phone directory, and the code for any embedded applications software in the cell phone, including MCD utility 110 (and perhaps including MNSD utility, in an alternate embodiment).

All of the above-described components are packaged within an appropriately designed external housing/casing 205. Other components may be present within MNSD MCD 200 and alternatively, cell phone may comprise different configuration of components than those illustrated herein. For example, MNSD MCD 200 may also include a visual display device (LCD display) with associated driver and a clock module.

In implementation, one or more of the novel processes supported by the software components are provided via a seamless operation with a single execution of code. Also, for simplicity in describing the invention, and as a preferred embodiment, the collective body of code that performs the various functions described herein and/or the described features of the illustrative embodiments are collectively referred to hereinafter as a specific MCD utility. References to the specific utility (or execution thereof) thus cover the entire range of functions provided by the illustrative embodiments, which occur at/on MCD 100/200.

Those of ordinary skill in the art will appreciate that the hardware and configuration thereof depicted in FIG. 1a may vary depending on implementation. Thus, the depicted example is meant solely for illustration and is not meant to imply architectural limitations with respect to the present invention. For example, it is understood that the functions of the invention are applicable to other types of communication devices and that the illustrations of MCD 100/200 and description thereof as a specialized device is provided solely for illustration. For example, mobile computing device or mobile communication device (MCD) 100/200 may be a mobile phone, personal digital assistant (PDA), a Blackberry™, an Ipod®, iPhone®, or other similar potable device with the functionality to support MCD and the described features. Similarly, while described as a portable or mobile device, several of the features are also fully applicable to a non-portable device (e.g., desktop terminal) within a networking environment with similar functionality as that of MCD 110.

It is noted that some of the components illustrated in FIG. 1a are in other prior art commonly referenced as an operating system (OS). For example, the applications processor 204 may singly be referred to as an OS, and would use the software needed to operate the machine of the present invention. Additionally, in an other embodiment, the operating system may include the software and other hardware needed to enable the machine/smart phone to operate properly. For example, this embodiment of an OS may include the needed software that may be located in memory 218, and use the applications processor 204, flash memory 226, display 216, audio module 215, communications module 206A and B, and other circuitry as needed. However, reference is made to prior art cited in this application for a more detailed understanding of an OS and the present invention is not meant to redefine what constitutes a known OS, but merely to introduce that an OS is part of the machine constituting the subject invention.

It is noted that the electronic communication devices (MNSD MCD 200) includes smartphones, tablets or any other electronic communication device having the above components and capable of running the application for performing the contactless payment. The display device or display units used by the electronic communication device 200 may include LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices. Connectivity of these devices 200 with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document. Moreover, the present invention maybe implemented on applications that run on a single or variety of operating system platforms, including but not limited to OS X, WINDOWS, UNIX, IOS, ANDROID, SYMBIAN, LINUX, or embedded operating systems, such as VxWorks. The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files.

The users can access the application or download the application, which is available from an online application store such as, but not limited to, Google Play Store or App Store. The users are allowed to download the application and install in their electronic communication devices 200 such as smartphone. The users can launch the application and register into the application by providing a variety of user information and other payment information through a graphical user interface of the application displayed on the display unit of the device 200. The communication module associated with the electronic communication device enables the communication of the application with the server over a communication link established by the communication module. The communication link may include WLAN, mobile data communication or any other wireless communication means. The data provided by the users through the application are transferred to the server through the communication link established by the communication module. In some instances, the present application may include additional security modules in form of encryption to protect the data transferred between the server and the electronic communication device 200. In addition, the electronic communication device 200 also includes additional modules for providing the location information using GPS module associated with the device 200.

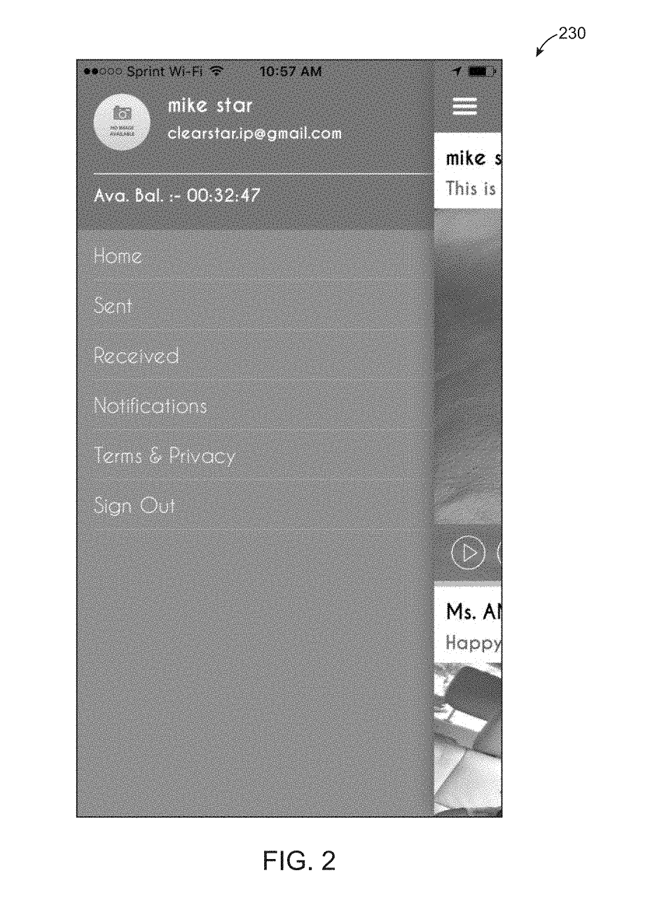

Turning now to FIG. 2, there is one embodiment of a screen shot of a navigation screen 230 for the invention loaded on a smart phone (mobile phone) application. In particular there are various tabs for the user to navigate the invention. For example, there is a HOME tab, SENT tab, RECEIVED tab, NOTIFICATIONS tab, and SIGN OUT tab. Each of these tabs will be discussed subsequently. The HOME tab takes the user to a page that shows all of the pictures/selfies that are on the network of all the other users of the service. The SENT tab takes the user to a page that shows all of the pictures/selfies that were sent by the user. The RECEIVED tab takes a user to the page that shows all the pictures/selfies that were received by the user from others. The NOTIFICATIONS tab takes the user to the page that receives notifications form the provider of the SELFIE software services. The SIGN OUT tab takes the user to the page that allows the user to sign off from the SELFIE site/application. Further, there is provided other features of the invention that are typical for many other smart phone applications, like the AVAILABLE BALANCE, abbreviated as Ava. Bal., which shows a balance of the number of minutes of audio recordings that have been paid for by the user.

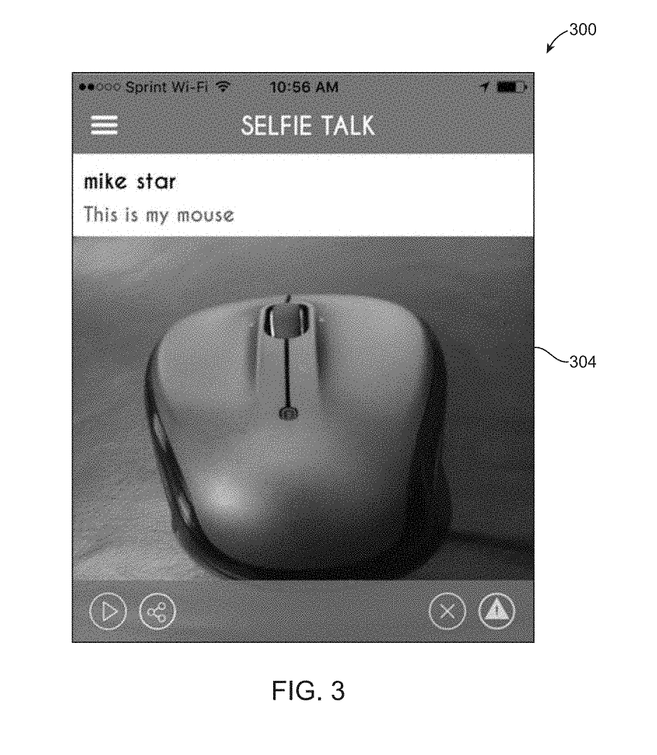

Turning now to FIG. 3, there is one embodiment of a screen shot of the HOME screen 300 of the present invention. In particular, there is illustrated the name of the application SELFIE TALK, the name of the user, mike star, the last selfie picture taken 304, and other elements typically found on such applications that are not discussed herein.

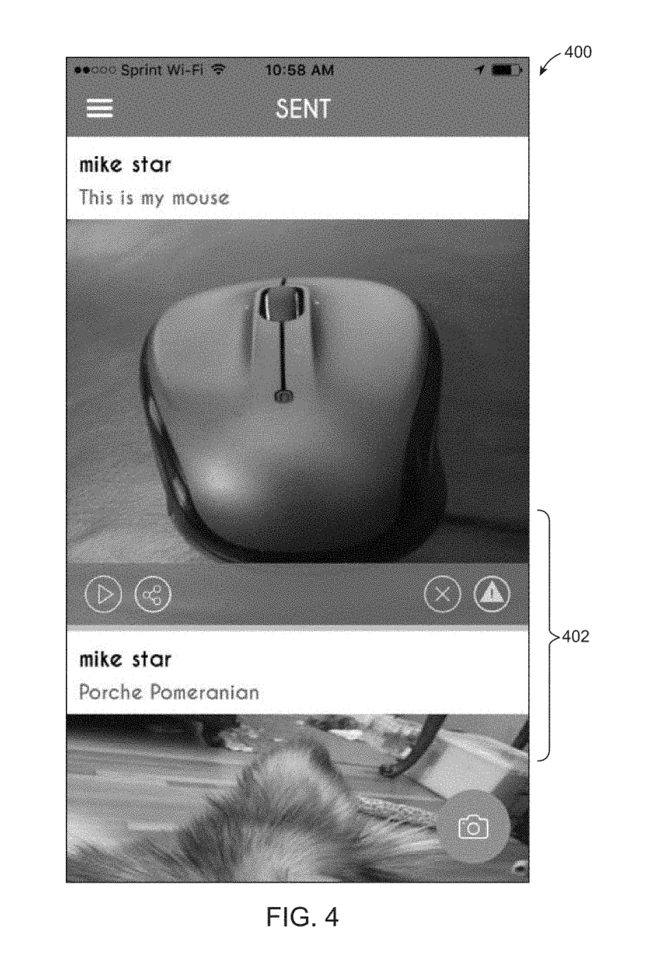

Regarding FIG. 4, there is one embodiment of a screen shot of what is illustrated on the SENT screen 400. In particular, there is provided a complete list of selfies 402 that were sent in chronological descending order.

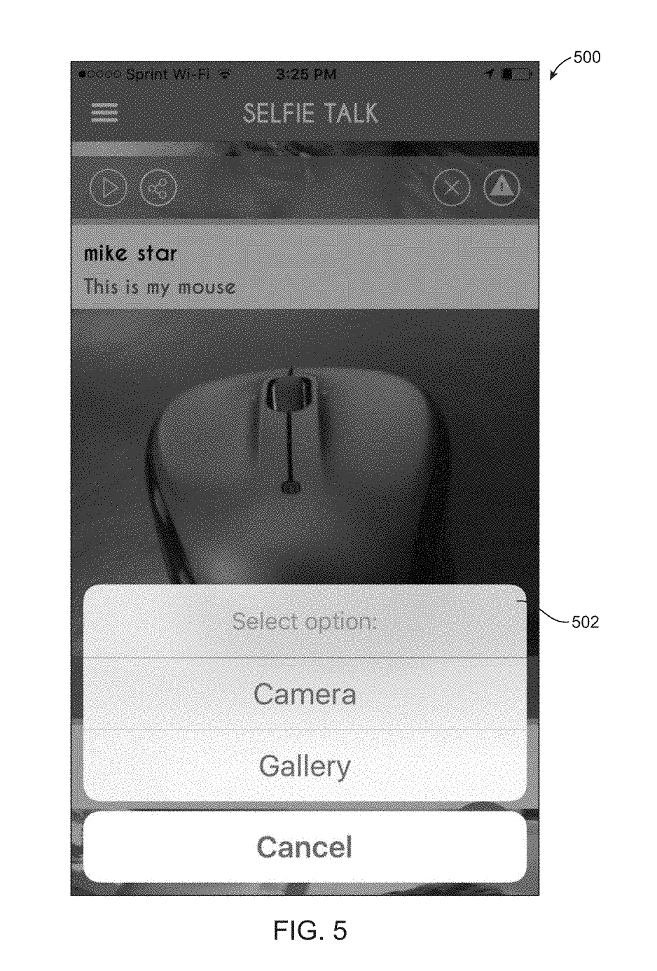

Starting with FIG. 5, there is one embodiment of a screen shot of the first step 500 of initiating the operation of the present invention. In particular, there is illustrated a menu 502 for selection options: CAMERA, GALLERY, and CANCEL. This allows a user to go to the camera and take a new picture, or go to the gallery of existing pictures that were already taken, or just cancel the picture selection step.

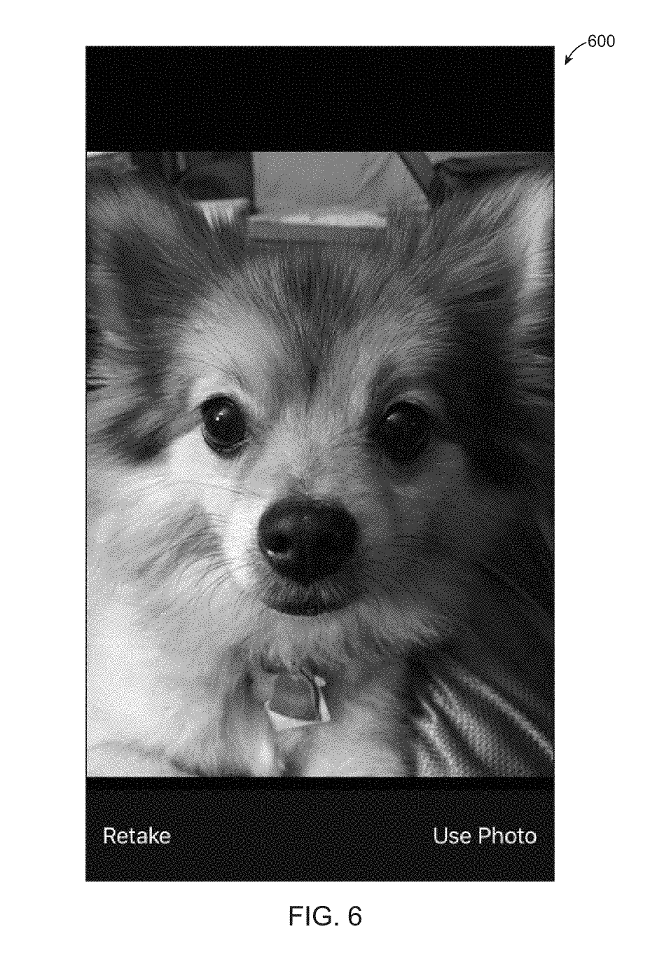

Next, there is FIG. 6, illustrating one embodiment of a screen shot of a picture 600 that was just taken with a cell/smart phone (not shown). Wherein, there is a RETAKE button, and a USE PHOTO button. If you select the RETAKE button, a user can take another picture and that will replace the existing picture shown on the screen. If the user selects the USE PHOTO option button, they may move onto the next screen.

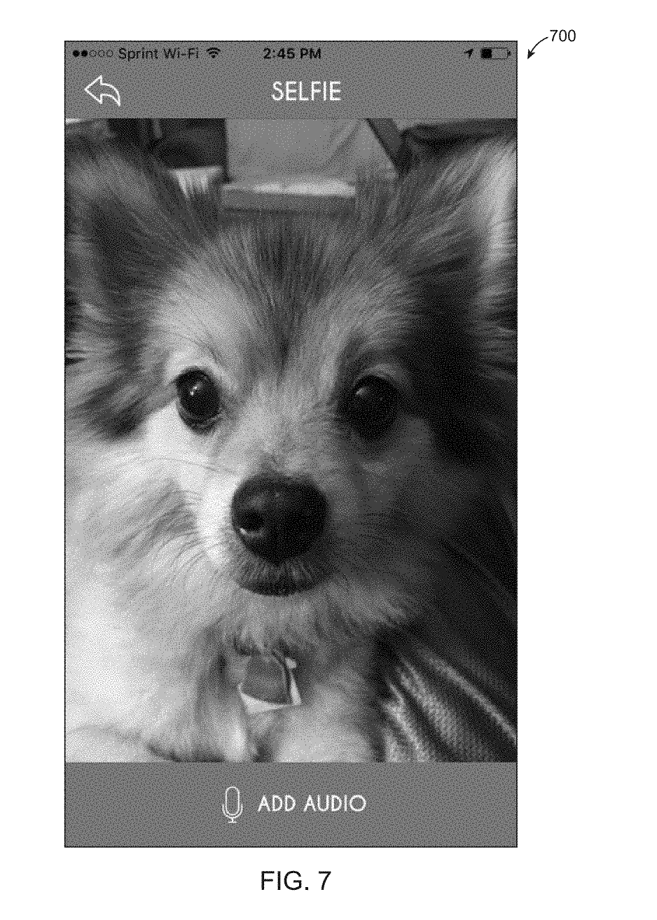

Next, there is FIG. 7 that illustrates one embodiment of a screen shot of the step of adding audio 700. There is an ADD AUDIO button, next to a picture of a microphone, which can then be selected by the user to record a short audio file to the picture/selfie.

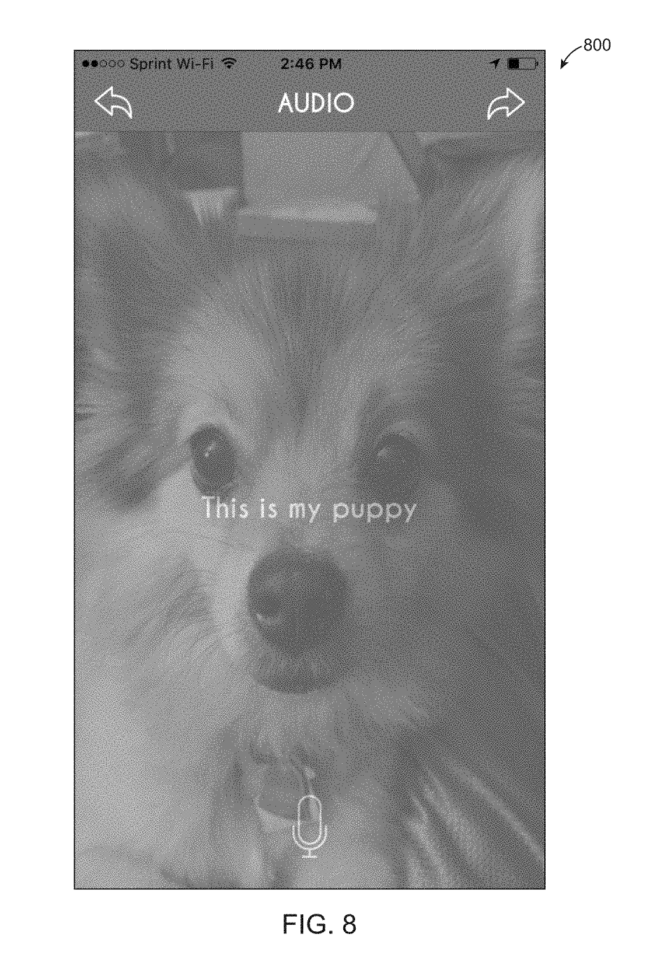

Next, there is FIG. 8 that illustrates one embodiment of a screen shot of the step of audio added 800. There is a short typed description of the audio recording taken in FIG. 7 that is automatically displayed. This step shows the selfie/picture in a faded shade image so that the user will only focus on the words that were transcribed from the audio. There is also a NEXT STEP button provided in the form of an arrow pointing to the right on the upper side of the screen shot to take the user to the caption added step.

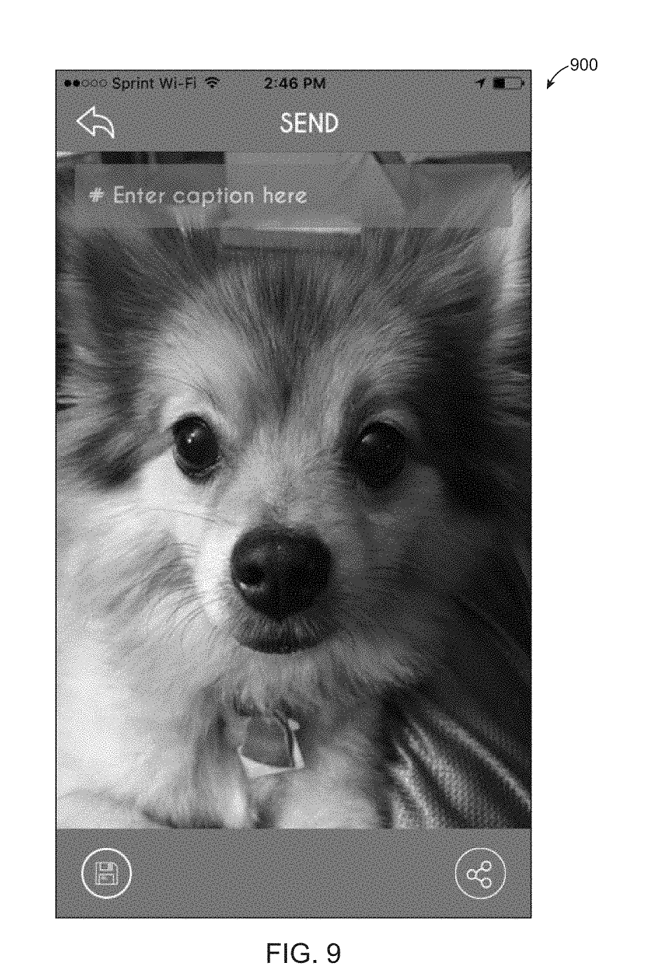

Next, there is FIG. 9 that illustrates one embodiment of a screen shot of step of CAPTION added 900. There is a text window provided, currently illustrated at a top portion of the screen where it reads “Enter caption here”, for adding a caption or label for the picture. By tapping the text window a typical keyboard will appear to allow the user to select the letters to spell out the desires short caption to be added and associated with the selfie/picture and audio file.

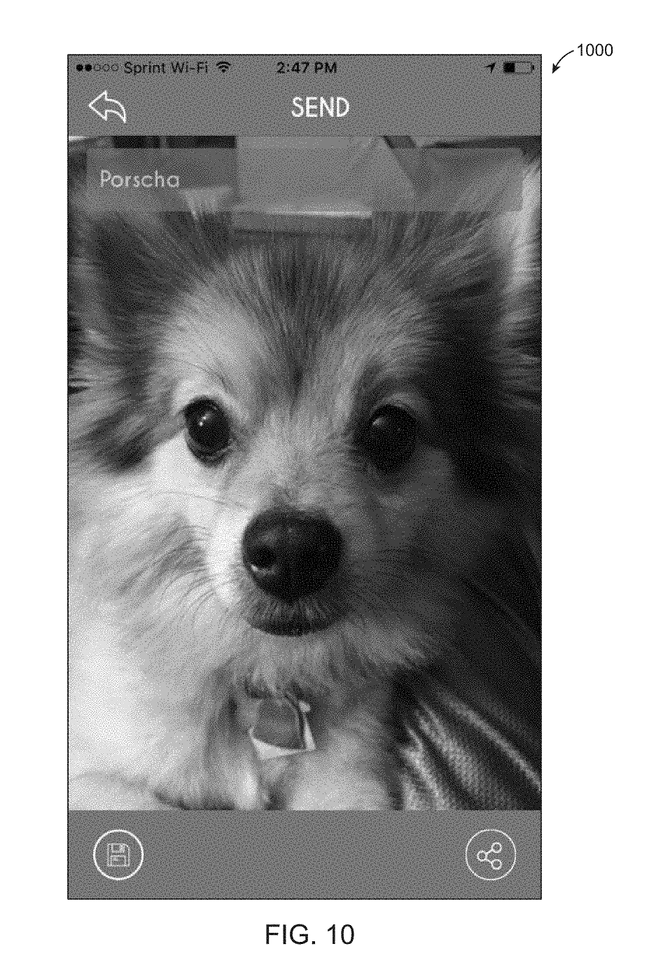

Next, there is FIG. 10 that illustrates one embodiment of a screen shot of the step after text was added 1000. There is shown the text 1010 that was added, illustrated as the wording: “Porscha”. There is also a SENDING button, illustrated at the bottom right as a circle around three small circles connected by two lines, illustrating that a single user can send the selfie/picture to others.

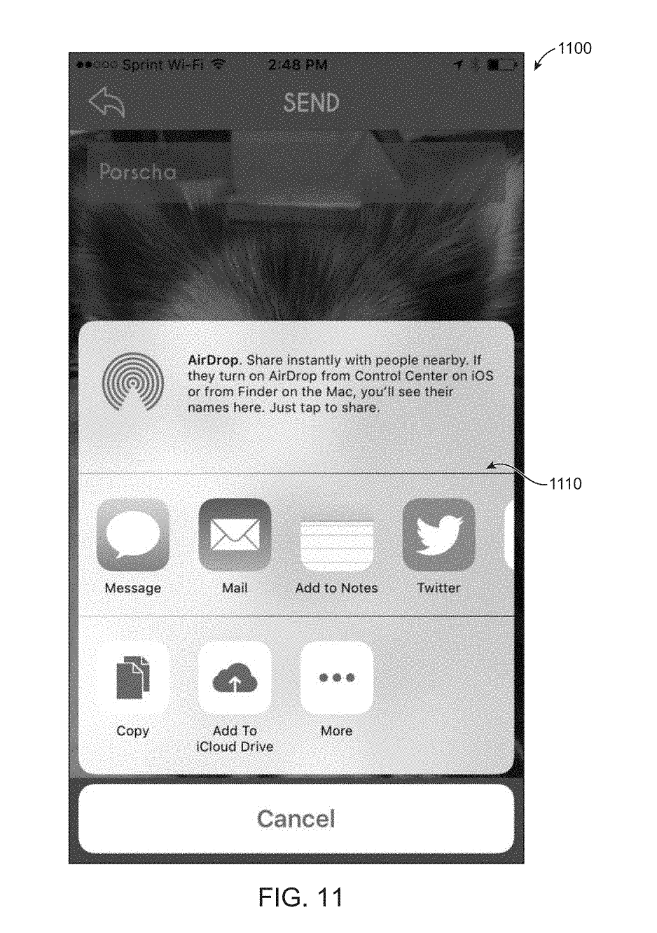

Next, there is FIG. 11 that illustrates one embodiment of a screen shot that upon activating this SENDING button, this sending screen 1100 will appear. In particular, a drop down window 1110 appears, allowing the user to select how the selfie/picture will be sent, like message, mail, Twitter, etc. as illustrated.

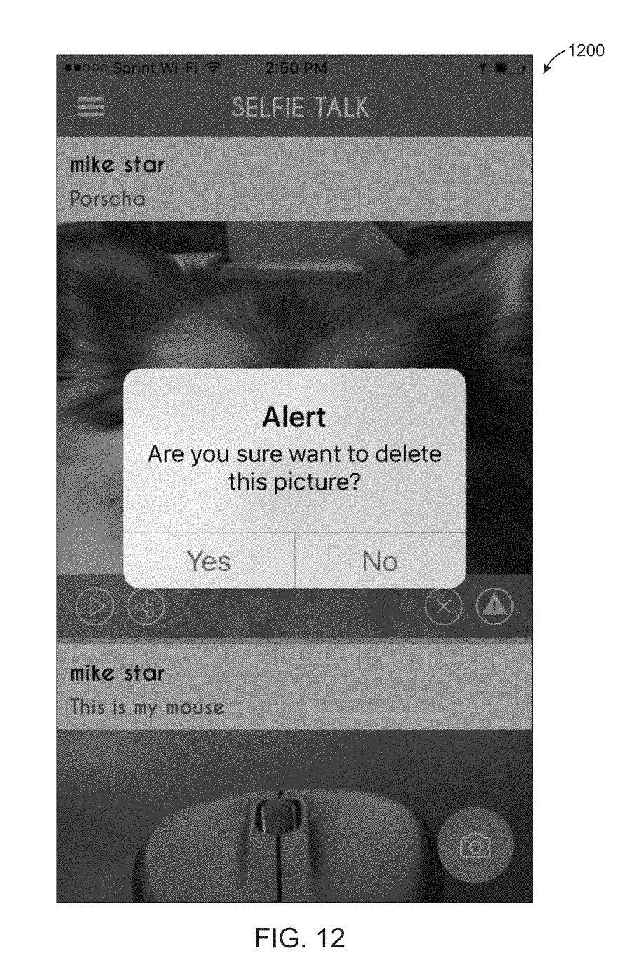

Regarding FIG. 12, there is one embodiment of a screen shot of deleting a photo 1200. In particular, as illustrated in the screen shot, there is an X with a circle around it, referred to as the DELETE button, and upon selection, a pop up window appears with the message: “ALERT, Are you sure you want to delete this picture?.”

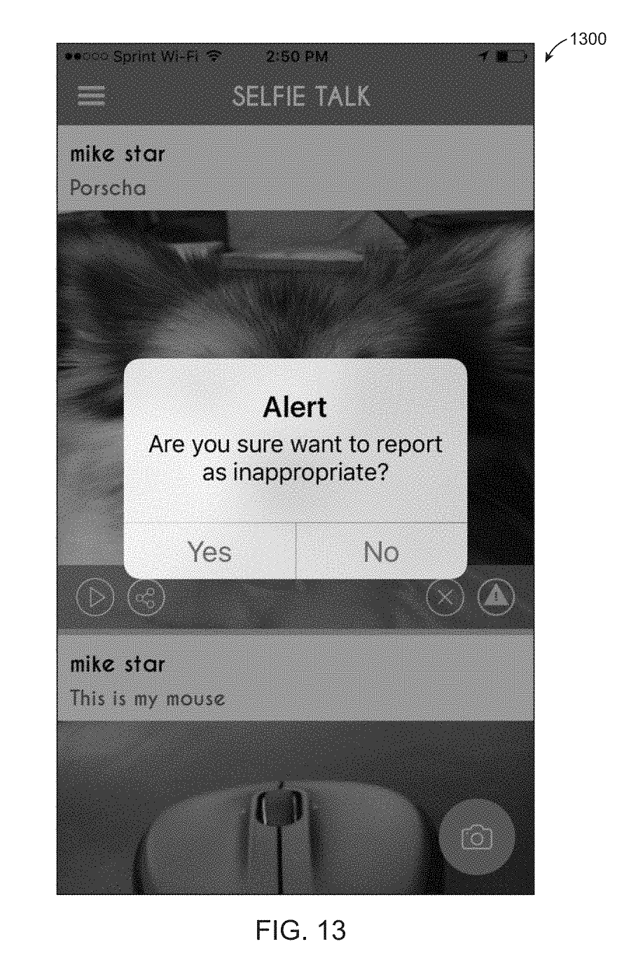

Regarding FIG. 13, there is one embodiment of a screen shot of inappropriate pictures alerts 1300. In particular, as illustrated in the screen shot, there is at the bottom right a triangle with an exclamation mark (!) in it, and shown within a circle, referred to as the INAPPROPRIATE button, and upon selection, a pop up window appears with the message: “ALERT, Are you sure you want to report as inappropriate?”

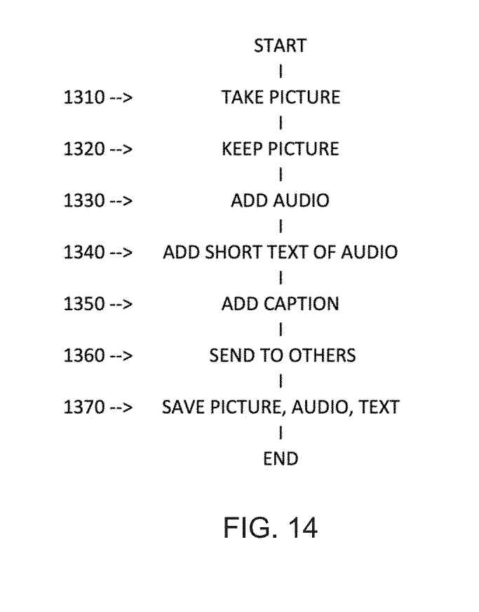

Referring to FIG. 14, there is one embodiment of a simplified flow chart of a general overall operation of the invention. Specifically, a user will take a picture 1310, this could be a selfie, picture, or any other picture that is found in the users gallery of past saved pictures. The user then selects to use or keep that picture 1320. Next, the user is enabled to add audio to the selected picture 1330. Next, a short text of the audio file recording associated with the selfie/picture is automatically written and illustrated over the picture/selfie 1340. Thereafter, the user is prompted to add a caption to the selected picture 1350. Whereby, the user is then prompted to select a method of sending the selected picture/selfie with the attached typed caption and recorded audio to others 1360. Whereby, the application that is loaded on a smartphone will automatically save the picture with the attached audio/recording and text/caption 1370.

It is noted that the operation of the subject invention has many aspects that are not discussed in this specification, which one skilled in the art would understand. For example, the technology for the operation of a cell phone is well understood, the operation of setting up applications to be used on a cell phone is well understood, the graphical user interface technology, the technology of taking pictures, sending pictures, saving pictures is well known, the technology for associating text with pictures is understood, the idea of having audio is well understood by skilled artisans. However, it is new and unobvious to have a system, method on a smartphone application that enables the user to take a selfie and immediately add audio and text to the picture, which is then all assembled into a single unit of data, which is then sendable via multiple platforms and saved.

It is noted that the preceding disclosure constitutes a new machine that can perform the identified features. This invention constitutes a new machine that uses many commonly found operating technologies, technologies like: cellular, satellite, Wi-Fi, computer, graphics, camera, data storage, data transmission, audio, and mechanical systems, which are all found in todays smart phone. All of these items to enable this invention are incorporated by reference for their supportive teachings through the prior art cited in the background of the invention.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

Although the invention has been explained in relation to its preferred embodiment, it is to be understood that many other possible modifications and variations can be made without departing from the spirit and scope of the invention.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

I claim:

1. A machine configured to enable a user to take a picture and associate audio and text data to the picture thereafter, and then send such associated data to others, the machine comprising:
a. a computing device, having:
i. an applications processor, designed to control the processing of data needed to operate the machine;
ii. a memory, operatively coupled to the applications processor, for storing at least a portion of software needed by the applications processor;
iii. an audio module, operatively coupled to the applications processor, designed to enable a user to create audio data;
iv. a communications module, operatively coupled to the applications processor, designed to enable the machine to send and receive data from other users having other similar machines; and
b. a camera, operatively coupled to the computing device, designed to create pictures and save them to the memory;
c. a display, operatively coupled to the computing device, designed to display the pictures, and to provide interaction with the user of the machine;
d. whereby, in a first step of operation, the machine prompts the user via the display to select a picture, either taken by the camera or stored in memory;
e. whereby, in a second step of operation, the machine prompts the user to record audio data and thereby attaching the audio data to the selected picture;
f. whereby, in a third step of operation, the machine prompts the user to create a text caption data to be displayed on the selected picture and thereby attaching the text caption data to the selected picture and audio data; and
g. whereby in a forth step of operation, the machine prompts the user to send to other users, via the communication module, the associated text caption data, audio data and selected picture.

2. A machine configured to enable a user to take a picture and associate audio and text data to the picture thereafter, and then send such associated data to others, the machine consisting essentially of:
a. a computing device, having:
i. an applications processor, designed to control the processing of data needed to operate the machine;
ii. a memory, operatively coupled to the applications processor, for storing at least a portion of software needed by the applications processor;
iii. an audio module, operatively coupled to the applications processor, designed to enable a user to create audio data;
iv. a communications module, operatively coupled to the applications processor, designed to enable the machine to send and receive data from other users having other similar machines; and
b. a camera, operatively coupled to the computing device, designed to create pictures and save them to the memory;
c. a display, operatively coupled to the computing device, designed to display the pictures, and to provide interaction with the user of the machine;
d. whereby, in a first step of operation, the machine prompts the user via the display to select a picture, either taken by the camera or stored in memory;
e. whereby, in a second step of operation, the machine prompts the user to record audio data and thereby attaching the audio data to the selected picture;
f. whereby, in a third step of operation, the machine prompts the user to create a text caption data to be displayed on the selected picture and thereby attaching the text caption data to the selected picture and audio data;
g. whereby in a forth step of operation, the machine prompts the user to send to other users, via the communication module, the associated text caption data, audio data and selected picture.

3. A smart phone configured to enable a user to take a picture and associate audio and text data to the picture thereafter, and then send such associated data to others, the smart phone comprising:
a. a computing device, having:
i. an applications processor, designed to control the processing of data needed to operate the smart phone;
ii. a memory, operatively coupled to the applications processor, for storing at least a portion of software needed by the applications processor;
iii. an audio module, operatively coupled to the applications processor, designed to enable a user to create audio data;
iv. a communications module, operatively coupled to the applications processor, designed to enable the apparatus to send and receive data from other users having another similar smart phone; and
b. a camera, operatively coupled to the computing device, designed to create pictures and save them to the memory;
c. a display, operatively coupled to the computing device, designed to display the pictures, and to provide interaction with the user of the smart phone;
d. whereby, in a first step of operation, the smart phone prompts the user via the display to select a picture, either taken by the camera or stored in memory;
e. whereby, in a second step of operation, the smart phone prompts the user to record audio data and thereby attaching the audio data to the selected picture;
f. whereby, in a third step of operation, the smart phone prompts the user to create a text caption data to be displayed on the selected picture and thereby attaching the text caption data to the selected picture and audio data;
g. whereby in a forth step of operation, the smart phone prompts the user to send to other users, via the communication module, the associated text caption data, audio data and selected picture.
